(19) United States
(12) Patent Application Publication
(10) Pub. No.: US 2006/0168070 A1
(43) Pub. Date: Jul. 27, 2006

(54) Hardware-based messaging appliance

(75) Inventors: J. Barry Thompson, New York, NY (US); Kul Singh, New York, NY (US); Pierre Fraval, New York, NY (US)

Correspondence Address: BROWN RAYSMAN MILLSTEIN FELDER & STEINER LLP, 303 TWIN DOLPHIN DRIVE, SUITE 600, REDWOOD SHORES, CA, 94065, US

(73) Assignee: Tervela, Inc., New York, NY (US)

(21) Appl. No.: 11/317,295

(22) Filed: Dec. 23, 2005

Related U.S. Application Data
(60) Provisional application No. 60/641,988, filed on Jan. 6, 2005.
(60) Provisional application No. 60/688,983, filed on Jun. 8, 2005.

(51) Int. Cl. G06F 15/16

(52) U.S. Cl. 709/206

(57) ABSTRACT

Message publish/subscribe systems are required to process high message volumes with reduced latency and performance bottlenecks. The hardware-based messaging appliance proposed by the present invention is designed for high-volume, low-latency messaging. The hardware-based messaging appliance is part of a publish/subscribe middleware system. With the hardware-based messaging appliances, this system operates to, among other things, reduce intermediary hops with neighbor-based routing, introduce efficient native-to-external and external-to-native protocol conversions, monitor system performance, including latency, in real time, employ topic-based and channel-based message communications, and dynamically optimize system interconnect configurations and message transmission protocols.

### REFERENCE TO EARLIER-FILED APPLICATIONS

This application claims the benefit of and incorporates by reference U.S. Provisional Application Ser. No. 60/641,988, filed Jan. 6, 2005, entitled “Event Router System and Method” and U.S. Provisional Application Ser. No. 60/688,983, filed Jun. 8, 2005, entitled “Hybrid Feed Handlers And Latency Measurement.”

This application is related to and incorporates by reference U.S. patent application Ser. No. ______ (Attorney Docket No. 50003-00004), Filed Dec. 23, 2005, entitled “End-To-End Publish/Subscribe Middleware Architecture.”

### FIELD OF THE INVENTION

The present invention relates to data messaging middleware architecture and more particularly to a hardware-based messaging appliance in messaging systems with a publish and subscribe (hereafter “publish/subscribe”) middleware architecture.

### BACKGROUND

The increasing level of performance required by data messaging infrastructures provides a compelling rationale for advances in networking infrastructure and protocols. Fundamentally, data distribution involves various sources and destinations of data, as well as various types of interconnect architectures and modes of communications between the data sources and destinations. Examples of existing data messaging architectures include hub-and-spoke, peer-to-peer and store-and-forward.

With the hub-and-spoke system configuration, all communications are transported through the hub, often creating performance bottlenecks when processing high volumes. Therefore, this messaging system architecture produces latency. One way to work around this bottleneck is to deploy more servers and distribute the network load across these different servers. However, such architecture presents scalability and operational problems. By comparison to a system with the hub-and-spoke configuration, a system with a peer-to-peer configuration creates unnecessary stress on the applications to process and filter data and is only as fast as its slowest consumer or node. Then, with a store-and-forward system configuration, in order to provide persistence, the system stores the data before forwarding it to the next node in the path. The storage operation is usually done by indexing and writing the messages to disk, which potentially creates performance bottlenecks. Furthermore, when message volumes increase, the indexing and writing tasks can be even slower and thus, can introduce additional latency.

Existing data messaging architectures share a number of deficiencies. One common deficiency is that data messaging in existing architectures relies on software that resides at the application level. This implies that the messaging infrastructure experiences OS (operating system) queuing and network I/O (input/output), which potentially create performance bottlenecks. Moreover, routing in conventional systems is implemented in software. Another common deficiency is that existing architectures use data transport protocols statically rather than dynamically even if other protocols might be more suitable under the circumstances. A few examples of common protocols include routable multicast, broadcast or unicast. Indeed, the application programming interface (API) in existing architectures is not designed to switch between transport protocols in real time.

Also, network configuration decisions are usually made at deployment time and are usually defined to optimize one set of network and messaging conditions under specific assumptions. The limitations associated with static (fixed) configuration preclude real time dynamic network reconfiguration. In other words, existing architectures are configured for a specific transport protocol which is not always suitable for all network data transport load conditions and therefore existing architectures are often incapable of dealing, in real-time, with changes or increased load capacity requirements.

Furthermore, when data messaging is targeted for particular recipients or groups of recipients, existing messaging architectures use routable multicast for transporting data across networks. However, in a system set up for multicast there is a limitation on the number of multicast groups that can be used to distribute the data and, as a result, the messaging system ends up sending data to destinations which are not subscribed to it (i.e., consumers which are not subscribers of this particular data). This increases consumers' data processing load and discard rate due to data filtering. Then, consumers that become overloaded for any reason and cannot keep up with the flow of data eventually drop incoming data and later ask for retransmissions. Retransmissions affect the entire system in that all consumers receive the repeat transmissions and all of them re-process the incoming data. Therefore, retransmissions can cause multicast storms and eventually bring the entire networked system down.

When the system is set up for unicast messaging as a way to reduce the discard rate, the messaging system may experience bandwidth saturation because of data duplication. For instance, if more than one consumer subscribes to a given topic of interest, the messaging system has to deliver the data to each subscriber, and in fact it sends a different copy of this data to each subscriber. And, although this solves the problem of consumers filtering out non-subscribed data, unicast transmission is non-scalable and thus not adaptable to substantially large groups of consumers subscribing to a particular data or to a significant overlap in consumption patterns.

Additionally, in the path between publishers and subscribers messages are propagated in hops between applications with each hop introducing application and operating system (OS) latency. Therefore, the overall end-to-end latency increases as the number of hops grows. Also, when routing messages from publishers to subscribers the message throughput along the path is limited by the slowest node in the path, and there is no way in existing systems to implement end-to-end messaging flow control to overcome this limitation.

One more common deficiency of existing architectures is their slow and often high number of protocol transformations. The reason for this is the IT (information technology) band-aid strategy in the Enterprise Application Integration (EAI) domain where more and more new technologies are integrated with legacy systems.

Hence, there is a need to improve data messaging systems performance in a number of areas. Examples where performance might need improvement are speed, resource allocation, latency, and the like.

### SUMMARY OF THE INVENTION

The present invention is based, in part, on the foregoing observations and on the idea that such deficiencies can be addressed with better results using a different approach that includes a hardware-based solution. These observations gave rise to the end-to-end message publish/subscribe middleware architecture for high-volume and low-latency messaging and particularly a hardware-based messaging appliance (MA). So therefore, a data distribution system with an end-to-end message publish/subscribe middleware architecture in accordance with the principles of the present invention can advantageously route significantly higher message volumes with significantly lower latency by, among other things, reducing intermediary hops with neighbor-based routing and network disintermediation, introducing efficient native-to-external and external-to-native protocol conversions, monitoring system performance, including latency, in real time, employing topic-based and channel-based message communications, and dynamically and intelligently optimizing system interconnect configurations and message transmission protocols. In addition, such system can provide guaranteed delivery quality of service with data caching.

In connection with resource allocation, a data distribution system in accordance with the present invention produces the advantage of dynamically allocating available resources in real time. To this end, instead of the conventional static configuration approach the present invention contemplates a system with real-time, dynamic, learned approach to resource allocation. Examples where resource allocation can be optimized in real time include network resources (usage of bandwidth, protocols, paths/routes) and consumer system resources (usage of CPU, memory, disk space).

In connection with monitoring system topology and performance, a data distribution system in accordance with the present invention advantageously distinguishes between message-level and frame-level latency measurements. In certain cases, the correlation between these measurements provides a competitive business advantage. In other words, the nature and extent of latency may indicate best data and source of data which, in turn, may be useful in business processes and provide a competitive edge.

Thus, in accordance with the purpose of the invention as shown and broadly described herein one exemplary system with a publish/subscribe middleware architecture includes: one or more messaging appliances configured for receiving and routing messages; a medium; and a provisioning and management appliance linked via the medium and configured for exchanging administrative messages with each messaging appliance. In such system, the messaging appliance executes the routing of messages by dynamically selecting a message transmission protocol and a message routing path.

In further accordance with the purpose of the present invention, a messaging appliance (MA) is configured as an edge MA or a core MA, where each MA has a high-speed interconnect bus through which the various hardware modules are linked, and the edge MA has, in addition, a protocol translation engine (PTE). In each MA, the hardware modules are divided essentially into three plane module groups, the control plane, the data plane and the service plane modules, respectively.

In sum, these and other features, aspects and advantages of the present invention will become better understood from the description herein, appended claims, and accompanying drawings as hereafter described.

### BRIEF DESCRIPTION OF THE DRAWINGS

The accompanying drawings which are incorporated in and constitute a part of this specification illustrate various aspects of the invention and together with the description, serve to explain its principles. Wherever convenient, the same reference numbers will be used throughout the drawings to refer to the same or like elements.

FIG. 1 illustrates an end-to-end middleware architecture in accordance with the principles of the present invention.

FIG. 1a is a diagram illustrating an overlay network.

FIG. 2 is a diagram illustrating an enterprise infrastructure implemented with an end-to-end middleware architecture according to the principles of the present invention.

FIG. 2a is a diagram illustrating an enterprise infrastructure physical deployment with the message appliances (MAs) creating a network backbone disintermediation.

FIG. 3 illustrates a channel-based messaging system architecture.

FIG. 4 illustrates one possible topic-based message format.

FIG. 5 shows a topic-based message routing and routing table.

FIGS. 6a-d are diagrams of various aspects of a hardware-based messaging appliance.

FIG. 6e illustrates the functional aspects of a hardware-based messaging appliance.

FIG. 7 illustrates the impact of adaptive message flow control.

### DETAILED DESCRIPTION

The description herein provides details of the end-to-end middleware architecture of a message publish-subscribe system and in particular the details of a hardware-based messaging appliance (MA) in accordance with various embodiments of the present invention. Before outlining the details of these various embodiments, however, the following is a brief explanation of terms used in this description. It is noted that this explanation is intended to merely clarify and give the reader an understanding of how such terms might be used, but without limiting these terms to the context in which they are used and without limiting the scope of the claims thereby.

The term “middleware” is used in the computer industry as a general term for any programming that mediates between two separate and often already existing programs. The purpose of adding the middleware is to offload from applications some of the complexities associated with information exchange by, among other things, defining communication interfaces between all participants in the network (publishers and subscribers). Typically, middleware programs provide messaging services so that different applications can communicate. With a middleware software layer, information exchange between applications is performed seamlessly. The systematic tying together of disparate applications, often through the use of middleware, is known as enterprise application integration (EAI). In this context, however, “middleware” can be a broader term used in connection with messaging between source and destination and the facilities deployed to enable such messaging; and, thus, middleware architecture covers the networking and computer hardware and software components that facilitate effective data messaging, individually and in combination as will be described below. Moreover, the terms “messaging system” or “middleware system,” can be used in the context of publish/subscribe systems in which messaging servers manage the routing of messages between publishers and subscribers. Indeed, the paradigm of publish/subscribe in messaging middleware is a scalable and thus powerful model.

The term “consumer” may be used in the context of client-server applications and the like. In one instance a consumer is a system or an application that uses an application programming interface (API) to register to a middleware system, to subscribe to information, and to receive data delivered by the middleware system. An API inside the publish/subscribe middleware architecture boundaries is a consumer; and an external consumer is any publish/subscribe system (or external data destination) that doesn't use the API and for communications with which messages go through protocol transformation (as will be later explained).

The term “external data source” may be used in the context of data distribution and message publish/subscribe systems. In one instance, an external data source is regarded as a system or application, located within or outside the enterprise private network, which publishes messages in one of the common protocols or its own message protocol. An example of an external data source is a market data exchange that publishes stock market quotes which are distributed to traders via the middleware system. Another example of an external data source is transactional data. Note that in a typical implementation of the present invention, as will be later described in more detail, the middleware architecture adopts its unique native protocol to which data from external data sources is converted once it enters the middleware system domain, thereby avoiding multiple protocol transformations typical of conventional systems.

The term “external data destination” is also used in the context of data distribution and message publish/subscribe systems. An external data destination is, for instance, a system or application, located within or outside the enterprise private network, which is subscribing to information routed via a local/global network. One example of an external data destination could be the aforementioned market data exchange that handles transaction orders published by the traders. Another example of an external data destination is transactional data. Note that, in the foregoing middleware architecture messages directed to an external data destination are translated from the native protocol to the external protocol associated with the external data destination.

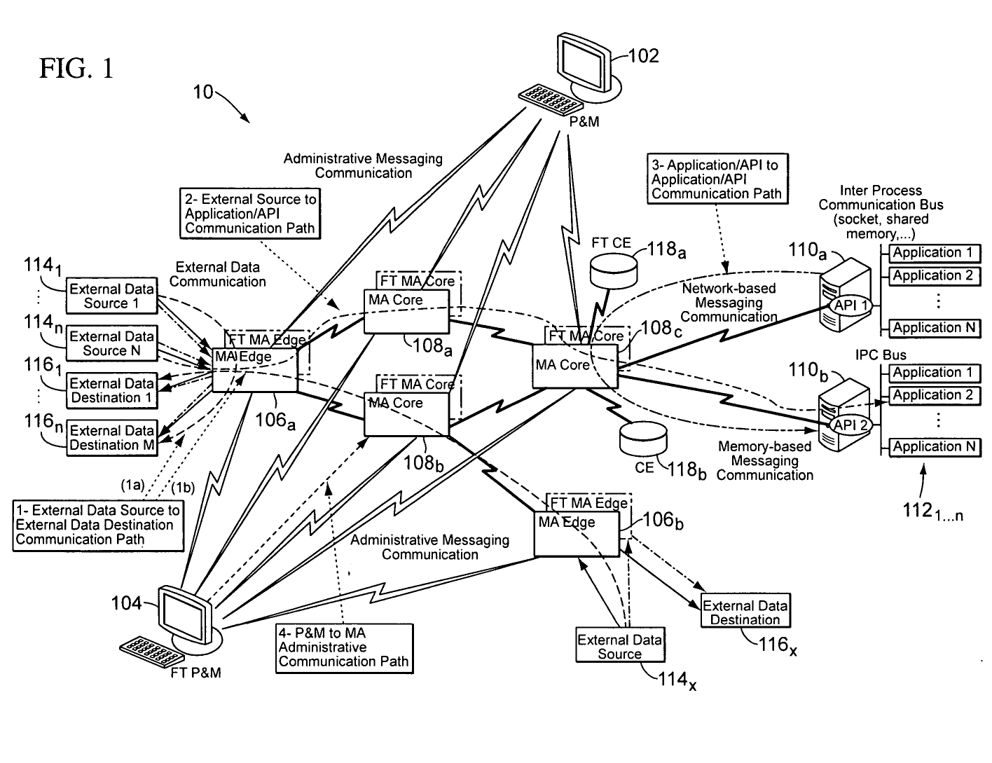

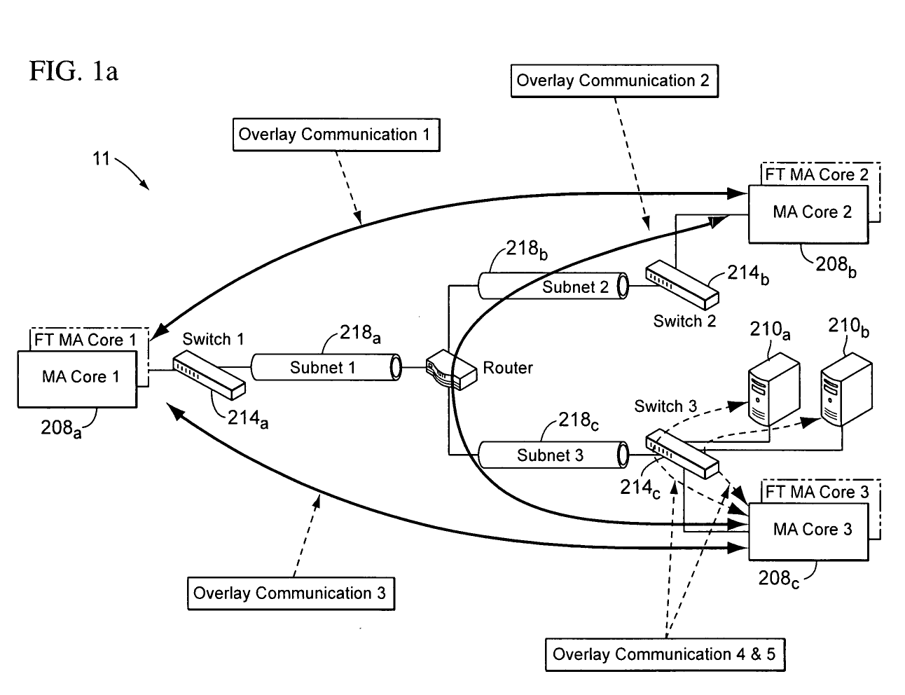

As can be ascertained from the description herein, the present invention can be practiced in various ways with the messaging appliance being implemented as a hardware-based solution in various configurations within the middleware architecture. The description therefore starts with an example of an end-to-end middleware architecture as shown in FIG. 1.

This exemplary architecture combines a number of beneficial features which include: messaging common concepts, APIs, fault tolerance, provisioning and management (P&M), quality of service (QoS—conflated, best-effort, guaranteed-while-connected, guaranteed-while-disconnected etc.), persistent caching for guaranteed delivery QoS, management of namespace and security service, a publish/subscribe ecosystem (core, ingress and egress components), transport-transparent messaging, neighbor-based messaging (a model that is a hybrid between hub-and-spoke, peer-to-peer, and store-and-forward, and which uses a subscription-based routing protocol that can propagate the subscriptions to all neighbors as necessary), late schema binding, partial publishing (publishing changed information only as opposed to the entire data) and dynamic allocation of network and system resources. As will be later explained, the publish/subscribe middleware system advantageously incorporates a fault tolerant design of the middleware architecture. In every publish/subscribe ecosystem there is at least one and more often two or more messaging appliances (MA) each of which being configured to function as an edge (egress/ingress) MA or a core MA. Note that the core MAs portion of the publish/subscribe ecosystem uses the aforementioned native messaging protocol (native to the middleware system) while the ingress and egress portions, the edge MAs, translate to and from this native protocol, respectively.

In addition to the publish/subscribe middleware system components, the diagram of FIG. 1 shows the logical connections and communications between them. As can be seen, the illustrated middleware architecture is that of a distributed system. In a system with this architecture, a logical communication between two distinct physical components is established with a message stream and associated message protocol. The message stream contains one of two categories of messages: administrative and data messages. The administrative messages are used for management and control of the different physical components, management of subscriptions to data, and more. The data messages are used for transporting data between sources and destinations, and in a typical publish/subscribe messaging there are multiple senders and multiple receivers of data messages.

With the structural configuration and logical communications as illustrated the distributed messaging system with the publish/subscribe middleware architecture is designed to perform a number of logical functions. One logical function is message protocol translation which is advantageously performed at an edge messaging appliance (MA) component. This is because communications within the boundaries of the publish/subscribe middleware system are conducted using the native protocol for messages independently from the underlying transport logic. This is why we refer to this architecture as a transport-transparent channel-based messaging architecture.

A second logical function is routing the messages from publishers to subscribers. Note that the messages are routed throughout the publish/subscribe network. Thus, the routing function is performed by each MA where messages are propagated, say, from an edge MA 106a-b (or API) to a core MA 108a-c or from one core MA to another core MA and eventually to an edge MA (e.g., 106b) or API 110a-b. The API 110a-b communicates with applications 112₁₋ₙ via an inter-process communication bus (sockets, shared memory etc.).

A third logical function is storing messages for different types of guaranteed-delivery quality of service, including for instance guaranteed-while-connected and guaranteed-while-disconnected. This is accomplished with the addition of store-and-forward functionality. A fourth function is delivering these messages to the subscribers (as shown, an API 106a-b delivers messages to subscribing applications 112₁₋ₙ).

In this publish/subscribe middleware architecture, the system configuration function as well as other administrative and system performance monitoring functions, are managed by the P&M system. Configuration involves both physical and logical configuration of the publish/subscribe middleware system network and components. The monitoring and reporting involves monitoring the health of all network and system components and reporting the results automatically, per demand or to a log. The P&M system performs its configuration, monitoring and reporting functions via administrative messages. In addition, the P&M system allows the system administrator to define a message namespace associated with each of the messages routed throughout the publish/subscribe network. Accordingly, a publish/subscribe network can be physically and/or logically divided into namespace-based sub-networks.

The P&M system manages a publish/subscribe middleware system with one or more MAs. These MAs are deployed as edge MAs or core MAs, depending on their role in the system. An edge MA is similar to a core MA in most respects, except that it includes a protocol translation engine that transforms messages from external to native protocols and from native to external protocols. Thus, in general, the boundaries of the publish/subscribe middleware architecture in a messaging system (i.e., the end-to-end publish/subscribe middleware system boundaries) are characterized by its edges at which there are edge MAs 106a-b and APIs 110a-b; and within these boundaries there are core MAs 108a-c.

Note that the system architecture is not confined to a particular limited geographic area and, in fact, is designed to transcend regional or national boundaries and even span across continents. In such cases, the edge MAs in one network can communicate with the edge MAs in another geographically distant network via existing networking infrastructures.

In a typical system, the core MAs 108a-c route the published messages internally within publish/subscribe middleware system towards the edge MAs or APIs (e.g., APIs 110a-b). The routing map, particularly in the core MAs, is designed for maximum volume, low latency, and efficient routing. Moreover, the routing between the core MAs can change dynamically in real-time. For a given messaging path that traverses a number of nodes (core MAs), a real time change of routing is based on one or more metrics, including network utilization, overall end-to-end latency, communications volume, network and/or message delay, loss and jitter.

Alternatively, instead of dynamically selecting the best performing path out of two or more diverse paths, the MA can perform multi-path routing based on message replication and thus send the same message across all paths. All the MAs located at convergence points of diverse paths will drop the duplicated messages and forward only the first arrived message. This routing approach has the advantage of optimizing the messaging infrastructure for low latency; although the drawback of this routing method is that the infrastructure requires more network bandwidth to carry the duplicated traffic.

The edge MAs have the ability to convert any external message protocol of incoming messages to the middleware system's native message protocol; and from native to external protocol for outgoing messages. That is, an external protocol is converted to the native (e.g., Tervela™) message protocol when messages are entering the publish/subscribe network domain (ingress); and the native protocol is converted into the external protocol when messages exit the publish/subscribe network domain (egress). The edge MAs operate also to deliver the published messages to the subscribing external data destinations.

Additionally, both the edge and the core MAs 106a-b and 108a-c are capable of storing the messages before forwarding them. One way this can be done is with a caching engine (CE) 118a-b. One or more CEs can be connected to the same MA. Theoretically, the API is said not to have this store-and-forward capability although in reality an API 110a-b could store messages before delivering them to the application, and it can store messages received from applications before delivering them to a core MA, edge MA or another API.

When an MA (edge or core MA) has an active connection to a CE, it forwards all or a subset of the routed messages to the CE which writes them to a storage area for persistency. For a predetermined period of time, these messages are then available for retransmission upon request. Examples where this feature is implemented are data replay, partial publish and various quality of service levels. Partial publish is effective in reducing network and consumers load because it requires transmission only of updated information rather than of all information.

To illustrate how the routing maps might affect routing, a few examples of the publish/subscribe routing paths are shown in FIG. 1. In this illustration, the middleware architecture of the publish/subscribe network provides five or more different communication paths between publishers and subscribers.

The first communication path links an external data source to an external data destination. The published messages received from the external data source 114₁₋ₙ are translated into the native (e.g., Tervela™) message protocol and then routed by the edge MA 106a. One way the native protocol messages can be routed from the edge MA 106a is to an external data destination 116n. This path is called out as communication path 1a. In this case, the native protocol messages are converted into the external protocol messages suitable for the external data destination. Another way the native protocol messages can be routed from the edge MA 106b is internally through a core MA 108b. This path is called out as communication path 1b. Along this path, the core MA 108b routes the native messages to an edge MA 106a. However, before the edge MA 106a routes the native protocol messages to the external data destination 116₁, it converts them into an external message protocol suitable for this external data destination 116₁. As can be seen, this communication path doesn't require the API to route the messages from the publishers to the subscribers. Therefore, if the publish/subscribe middleware system is used for external source-to-destination communications, the system need not include an API.

Another communication path, called out as communications path 2, links an external data source 114n to an application using the API 110b. Published messages received from the external data source are translated at the edge MA 106a into the native message protocol and are then routed by the edge MA to a core MA 108a. From the first core MA 108a, the messages are routed through another core MA 108c to the API 110b. From the API the messages are delivered to subscribing applications (e.g., 112₂). Because the communication paths are bidirectional, in another instance, messages could follow a reverse path from the subscribing applications 112₁₋ₙ to the external data destination 116n. In each instance, core MAs receive and route native protocol messages while edge MAs receive external or native protocol messages and, respectively, route native or external protocol messages (edge MAs translate to/from such external message protocol to/from the native message protocol). Each edge MA can an ingress message simultaneously to both native protocol channels and external protocol channels regardless of whether this ingress message comes in as a native or external protocol message. As a result, each edge MA can route an ingress message simultaneously to both external and internal consumers, where internal consumers consume native protocol messages and external consumers consume external protocol messages. This capability enables the messaging infrastructure to seamlessly and smoothly integrate with legacy applications and systems.

Yet another communication path, called out as communications path 3, links two applications, both using an API 110a-b. At least one of the applications publishes messages or subscribes to messages. The delivery of published messages to (or from) subscribing (or publishing) applications is done via an API that sits on the edge of the publish/subscribe network. When applications subscribe to messages, one of the core or edge MAs routes the messages towards the API which, in turn, notifies the subscribing applications when the data is ready to be delivered to them. Messages published from an application are sent via the API to the core MA 108c to which the API is ‘registered’.

Note that by ‘registering’ (logging in) with an MA, the API becomes logically connected to it. An API initiates the connection to the MA by sending a registration (‘log-in’ request) message to the MA's. After registration, the API can subscribe to particular topics of interest by sending its subscription messages to the MA. Topics are used for publish/subscribe messaging to define shared access domains and the targets for a message, and therefore a subscription to one or more topics permits reception and transmission of messages with such topic notations. The P&M sends to the MAs in the network periodic entitlement updates and each MA updates it own table accordingly. Hence, if the MA find the API to be entitled to subscribe to a particular topic (the MA verifies the API's entitlements using the routing entitlements table) the MA activates the logical connection to the API. Then, if the API is properly registered with it, the core MA 108c routes the data to the second API 110 as shown. In other instances this core MA 108b may route the messages through additional one or more core MAs (not shown) which route the messages to the API 110b that, in turn, delivers the messages to subscribing applications 112₁₋ₙ.

As can be seen, communications path 3 doesn't require the presence of an edge MA, because it doesn't involve any external data message protocol. In one embodiment exemplifying this kind of communications path, an enterprise system is configured with a news server that publishes to employees the latest news on various topics. To receive the news, employees subscribe to their topics of interest via a news browser application using the API.

Note that the middleware architecture allows subscription to one or more topics. Moreover, this architecture allows subscription to a group of related topics with a single subscription request, by allowing wildcards in the topic notation.

Yet another path, called out as communications path 4, is one of the many paths associated with the P&M system 102 and 104 with each of them linking the P&M to one of the MAs in the publish/subscribe network middleware architecture. The messages going back and forth between the P&M system and each MA are administrative messages used to configure and monitor that MA. In one system configuration, the P&M system communicates directly with the MAs. In another system configuration, the P&M system communicates with MAs through other MAs. In yet another configuration the P&M system can communicate with the MAs both directly or indirectly.

In a typical implementation, the middleware architecture can be deployed over a network with switches, routers and other networking appliances, and it employs channel-based messaging capable of communications over any type of physical medium. One exemplary implementation of this fabric-agnostic channel-based messaging is an IP-based network. In this environment, all communications between all the publish/subscribe physical components are performed over UDP (User Datagram Protocol), and the transport reliability is provided by the messaging layer. An overlay network according to this principle is illustrated in FIG. 1a.

As shown, overlay communications 1, 2 and 3 can occur between the three core MAs 208a-c via switches 214a-c, a router 216 and subnets 218a-c. In other words, these communication paths can be established on top of the underlying network which is composed of networking infrastructure such as subnets, switches and routers, and, as mentioned, this architecture can span over a large geographic area (different countries and even different continents).

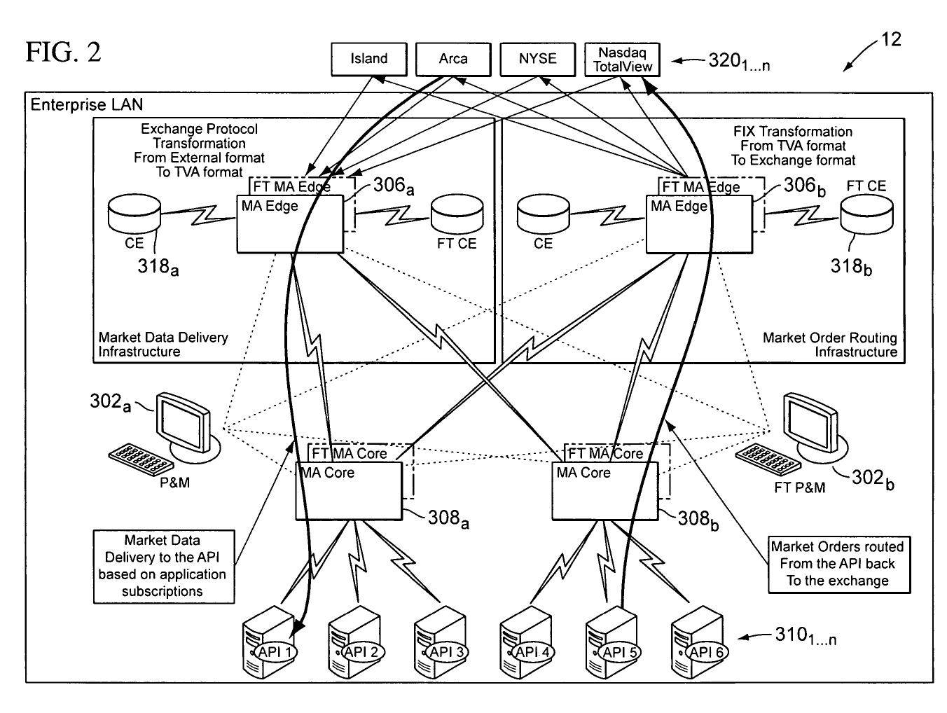

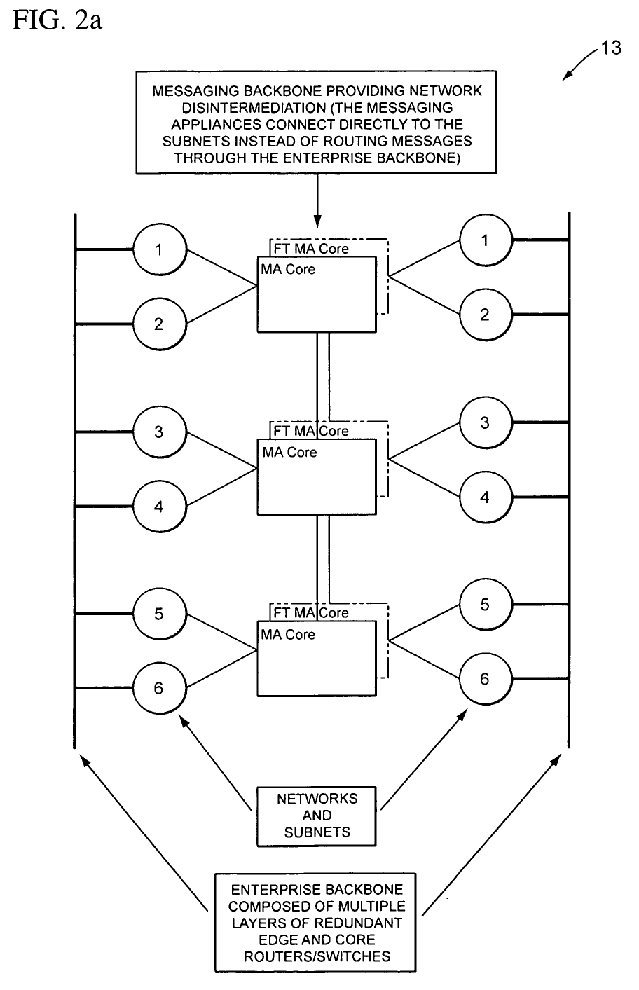

Notably, the foregoing and other end-to-end middleware architectures according to the principles of the present invention can be implemented in various enterprise infrastructures in various business environments. One such implementation is illustrated on FIG. 2.

In this enterprise infrastructure, a market data distribution plant 12 is built on top of the publish/subscribe network for routing stock market quotes from the various market data exchanges 320₁₋ₙ to the traders (applications not shown). Such an overlay solution relies on the underlying network for providing interconnects, for instance, between the MAs as well as between such MAs and the P&M system. Market data delivery to the APIs 310₁₋ₙ is based on applications subscription. With this infrastructure, traders using the applications (not shown) can place transaction orders that are routed from the APIs 310₁₋ₙ through the publish/subscribe network (via core MAs 308a-b and the edge MA 306a) back to the market data exchanges 320₁₋ₙ.

An example of the underlying physical deployment is illustrated on FIG. 2a. As shown, the MAs are directly connected to each other and plugged directly into the networks and subnets, in which the consumers and publishers of messaging traffic are physically connected. In this case, interconnects would be direct connections, say between the MAs as well as between them and the P&M system. This enables a network backbone disintermediation and a physical separation of the messaging traffic from other enterprise applications traffic. Effectively, the MAs can be used to remove the reliance on traditional routed network for the messaging traffic.

In this example of physical deployment, the external data sources or destinations, such as market data exchanges, are directly connected to edge MAs, for instance edge MA 1. The consuming or publishing applications of messaging traffic, such as trading applications, are connected to the subnets 1-12. These applications have at least two ways to subscribe, publish or communicate with other applications; they could either use the enterprise backbone, composed of multiple layers of redundant routers and switches, which carries all enterprise application traffic, including—but not limited to—messaging traffic, or use the messaging backbone, composed of edge and core MAs directly interconnected to each other via an integrated switch. Using an alternative backbone has the benefit of isolating the messaging traffic from other enterprise application traffic, and thus, better controlling the performance of the messaging traffic. In one implementation, an application located in subnet 6 logically or physically connected to the core MA 3, subscribes to or publishes messaging traffic in the native protocol, using the Tervela API. In another implementation, an application located in subnet 7 logically or physically connected to the edge MA 1, subscribes to or publishes the messaging traffic in an external protocol, where the MA performs the protocol transformation using the integrated protocol transformation engine module.

Logically, the physical components of the publish/subscribe network are built on a messaging transport layer akin to layers 1 to 4 of the Open Systems Interconnection (OSI) reference model. Layers 1 to 4 of the OSI model are respectively the Physical, Data Link, Network and Transport layers.

Thus, in one embodiment of the invention, the publish/subscribe network can be directly deployed into the underlying network/fabric by, for instance, inserting one or more messaging line card in all or a subset of the network switches and routers. In another embodiment of the invention, the publish/subscribe network can be effectively deployed as a mesh overlay network (in which all the physical components are connected to each other). For instance, a fully-meshed network of 4 MAs is a network in which each of the MAs is connected to each of its 3 peer MAs. In a typical implementation, the publish/subscribe network is a mesh network of one or more external data sources and/or destinations, one or more provisioning and management (P&M) systems, one or more messaging appliances (MAs), one or more optional caching engines (CE) and one or more optional application programming interfaces (APIs).

As will be later explained in more detail, reliability, availability and consistency are often necessary in enterprise operations. For this purpose, the publish/subscribe middleware system can be designed for fault tolerance with several of its components being deployed as fault tolerant systems. For instance, MAs can be deployed as fault-tolerant MA pairs, where the first MA is called the primary MA, and the second MA is called the secondary MA or fault-tolerant MA (FT MA). Again, for store and forward operations, the CE (cache engine) can be connected to a primary or secondary core/edge MA. When a primary or secondary MA has an active connection to a CE, it forwards all or a subset of the routed messages to that CE which writes them to a storage area for persistency. For a predetermined period of time, these messages are then available for retransmission upon request.

As mentioned before, communications within the boundaries of each publish/subscribe middleware system are conducted using the native protocol for messages independently from the underlying transport logic. This is why we refer to this architecture as being a transport-transparent channel-based messaging architecture.

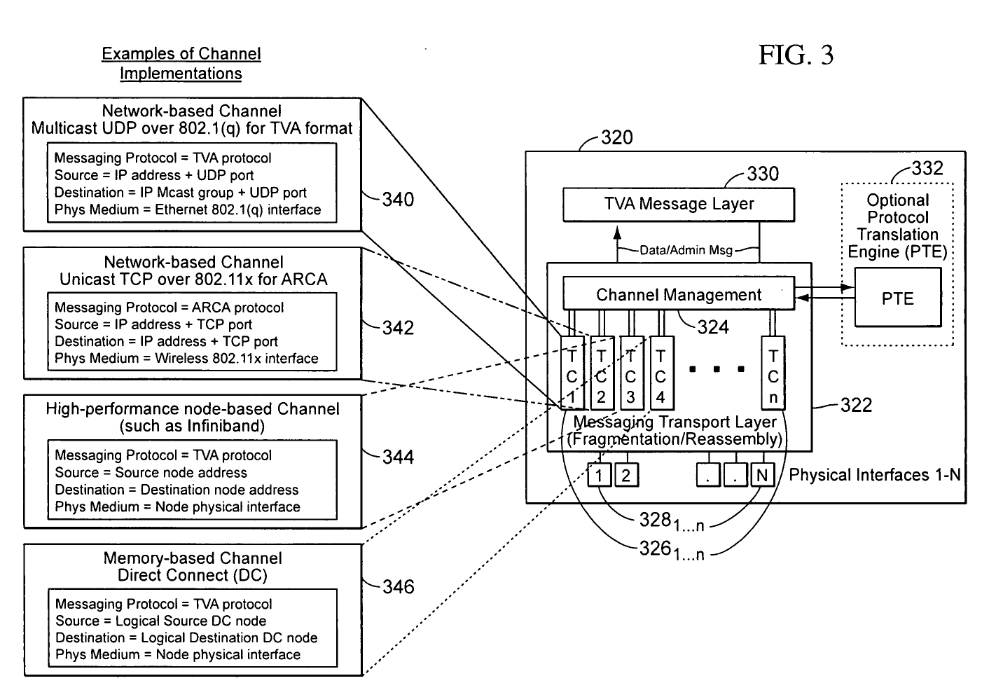

FIG. 3 illustrates in more details the channel-based messaging architecture 320. Generally, each communication path between the messaging source and destination is defined as a messaging transport channel. Each channel 326₁₋ₙ, is established over a physical medium with interfaces 328₁₋ₙ between the channel source and the channel destination. Each such channel is established for a specific message protocol, such as the native (e.g., Tervela™) message protocol or others. Only edge MAs (those that manage the ingress and egress of the publish/subscribe network) use the channel message protocol (external message protocol). Based on the channel message protocol, the channel management layer 324 determines whether incoming and outgoing messages require protocol translation. In each edge MA, if the channel message protocol of incoming messages is different from the native protocol, the channel management layer 324 will perform a protocol translation by sending the message for process through the protocol translation engine (PTE) 332 before passing them along to the native message layer 330. Also, in each edge MA, if the native message protocol of outgoing messages is different from the channel message protocol (external message protocol), the channel management layer 324 will perform a protocol translation by sending the message for process through the protocol translation engine (PTE) 332 before routing them to the transport channel 326₁₋ₙ. Hence, the channel manages the interface 328₁₋ₙ with the physical medium as well as the specific network and transport logic associated with that physical medium and the message reassembly or fragmentation.

In other words, a channel manages the OSI transport layers 322. Optimization of channel resources is done on a per channel basis (e.g., message density optimization for the physical medium based on consumption patterns, including bandwidth, message size distribution, channel destination resources and channel health statistics). Then, because the communication channels are fabric agnostic, no particular type of fabric is required. Indeed, any fabric medium will do, e.g., ATM, Infiniband or Ethernet.

Incidentally, message fragmentation or re-assembly may be needed when, for instance, a single message is split across multiple frames or multiple messages are packed in a single frame Message fragmentation or reassembly is done before delivering messages to the channel management layer.

FIG. 3 further illustrates a number of possible channels implementations in a network with the middleware architecture. In one implementation 340, the communication is done via a network-based channel using multicast over an Ethernet switched network which serves as the physical medium for such communications. In this implementation the source send messages from its IP address, via its UDP port, to the group of destinations (defined as an IP multicast address) with its associated UDP port. In a variation of this implementation 342, the communication between the source and destination is done over an Ethernet switched network using UDP unicast. From its IP address, the source sends messages, via a UDP port, to a select destination with a UDP port at its respective IP address.

In another implementation 344, the channel is established over an Infiniband interconnect using a native Infiniband transport protocol, where the Infiniband fabric is the physical medium. In this implementation the channel is node-based and communications between the source and destination are node-based using their respective node addresses. In yet another implementation 346, the channel is memory-based, such as RDMA (Remote Direct Memory Access), and referred to here as direct connect (DC). With this type of channel, messages are sent from a source machine directly into the destination machine's memory, thus, bypassing the CPU processing to handle the message from the NIC to the application memory space, and potentially bypassing the network overhead of encapsulating messages into network packets.

As to the native protocol, one approach uses the aforementioned native Tervela™ message protocol. Conceptually, the Tervela™ message protocol is similar to an IP-based protocol. Each message contains a message header and a message payload. The message header contains a number of fields one of which is for the topic information. As mentioned, a topic is used by consumers to subscribe to a shared domain of information.

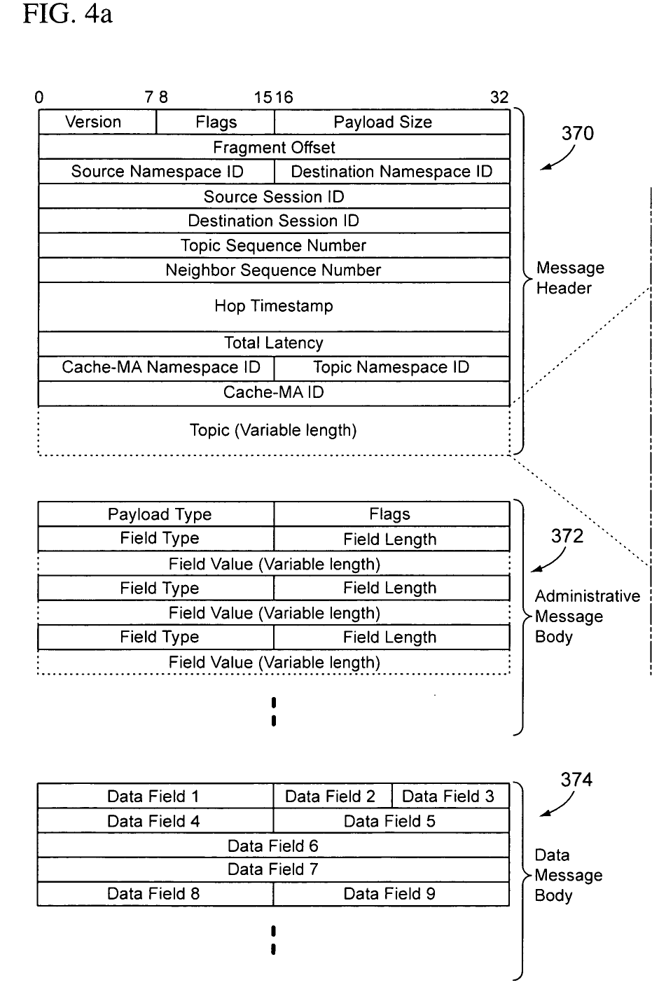

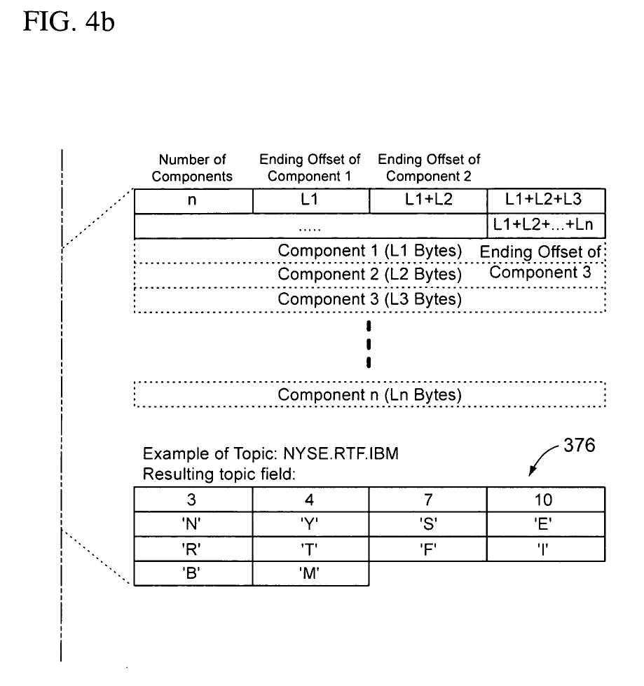

FIG. 4 illustrates one possible topic-based message format. As shown, messages include a header 370 and a body 372 and 374 which includes the payload. The two types of messages, data and administrative are shown with different message bodies and payload types. The header includes fields for the source and destination namespace identifications, source and destination session identifications, topic sequence number and hope timestamp, and, in addition, it includes the topic notation field (which is preferably of variable length). The topic might be defined as a token-based string, such as NYSE.RTF.IBM 376 which is the topic string for messages containing the real time quote of the IBM stock.

In some embodiment, the topic information in the message might be encoded or mapped to a key, which can be one or more integer values. Then, each topic would be mapped to a unique key, and the mapping database between topics and keys would be maintained by the P&M system and updated over the wire to all MAs. As a result, when an API subscribes or publishes to one topic, the MA is able to return the associated unique key that is used for the topic field of the message.

Preferably, the subscription format will follow the same format as the message topic. However, the subscription format also supports wildcard-matching with any topic substring as well as regular expression pattern-matching with the topic string. Mapping wildcards to actual topics may be dependant on the P&M subsystem or it can be handled by the MA, depending on the complexity of the wildcard or pattern-match request.

For instance, pattern matching may follow rules such as:

Example #1: a string with a wildcard of T1.*.T3.T4 would match T1.T2a.T3.T4 and T1.T2b.T3.T4 but would not match T1.T2.T3.T4.T5

Example #2: a string with wildcards of T1.*.T3.T4.* would not match T1.T2a.T3.T4 and T1.T2b.T3.T4 but it would match T1.T2.T3.T4.T5

Example #3: a string with wildcards of T1.*.T3.T4.[*] (optional 5^{th} element) would match T1.T2a.T3.T4, T1.T2b.T3.T4 and T1.T2.T3.T4.T5 but would not match T1.T2.T3.T4.T5.T6

Example #4: a string with a wildcard of T1.T2*.T3.T4 would match T1.T2a.T3.T4 and T1.T2b.T3.T4 but would not match T1.T5a.T3.T4

Example #5: a string with wildcards of T1.*.T3.T4.>(any number of trailing elements) would match T1.T2a.T3.T4, T1.T2b.T3.T4, T1.T2.T3.T4.T5 and T1.T2.T3.T4.T5.T6.

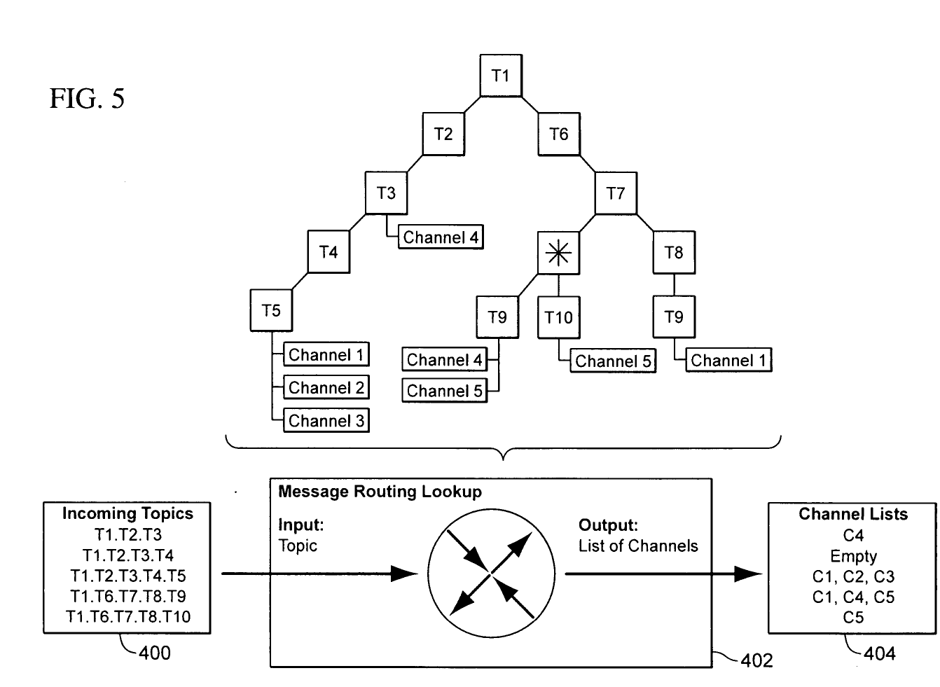

FIG. 5 shows topic-based message routing. As indicated, a topic might be defined as a token-based string, such as T1.T2.T3.T4, where T1, T2, T3 and T4 are strings of variable lengths. As can be seen, incoming messages with particular topic notations 400 are selectively routed to communications channels 404, and the routing determination is made based on a routing table 402. The mapping of the topic subscription to the channel defines the route and is used to propagate messages throughout the publish/subscribe network. The superset of all these routes, or mapping between subscriptions and channels, defines the routing table. The routing table is also referred to as the subscription table. The subscription table for routing via string-based topics can be structured in a number of ways, but is preferably configured for optimizing its size as well as the routing lookup speed. In one implementation, the subscription table may be defined as a dynamic hash map structure, and in another implementation, the subscription table may be arranged in a tree structure as shown in the diagram of FIG. 5.

A tree includes nodes (e.g., T₁, . . . T₁₀) connected by edges, where each sub-string of a topic subscription corresponds to a node in the tree. The channels mapped to a given subscription are stored on the leaf node of that subscription indicating, for each leaf node, the list of channels from where the topic subscription came (i.e. through which subscription requests were received). This list indicates which channel should receive a copy of the message whose topic notation matches the subscription. As shown, the message routing lookup takes a message topic as input and parse the tree using each substring of that topic to locate the different channels associated with the incoming message topic. For instance, T₁, T₂, T₃, T₄ and T₅ are directed to channels 1, 2 and 3; T₁, T₂, and T₃, are directed to channel 4; T₁, T₆, T₇, T* and T₉ are directed to channels 4 and 5; T₁, T₆, T₇, T₉ and T₉ are directed to channel 1; and T₁, T₆, T₇, T* and T₁₀ are directed to channel 5.

Although selection of the routing table structure is intended to optimize the routing table lookup, performance of the lookup depends also on the search algorithm for finding the one or more topic subscriptions that match an incoming message topic. Therefore, the routing table structure should be able to accommodate such algorithm and vice versa. One way to reduce the size of the routing table is by allowing the routing algorithm to selectively propagate the subscriptions throughout the entire publish/subscribe network. For example, if a subscription appears to be a subset of another subscription (e.g., a portion of the entire string) that has already been propagated, there is no need to propagate the subset subscription since the MAs already have the information for the superset of this subscription.

Based on the foregoing, the preferred message routing protocol is a topic-based routing protocol, where entitlements are indicated in the mapping between subscribers and respective topics. Entitlements are designated per subscriber or groups/classes of subscribers and indicate what messages the subscriber has a right to consume, or which messages may be produced (published) by such publisher. These entitlements are defined in the P&M machine, communicated to all MAs in the publish/subscribe network, and then used by the MA to create and update their routing tables.

Each MA updates its routing table by keeping track of who is interested in (requesting subscription to) what topic. However, before adding a route to its routing table, the MA has to check the subscription against the entitlements of the publish/subscribe network. The MA verifies that a subscribing entity, which can be a neighboring MA, the P&M system, a CE or an API, is authorized to do so. If the subscription is valid, the route will be created and added to the routing table. Then, because some entitlements may be known in advance, the system can be deployed with predefined entitlements and these entitlements can be automatically loaded at boot time. For instance, some specific administrative messages such as configuration updates or the like might be always forwarded throughout the network and therefore automatically loaded at startup time.

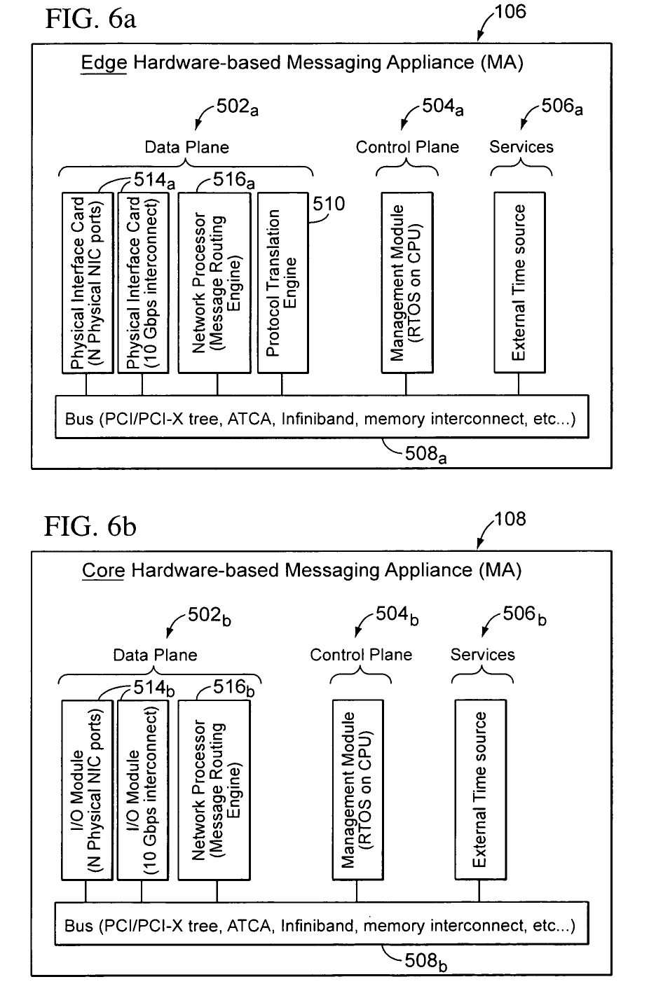

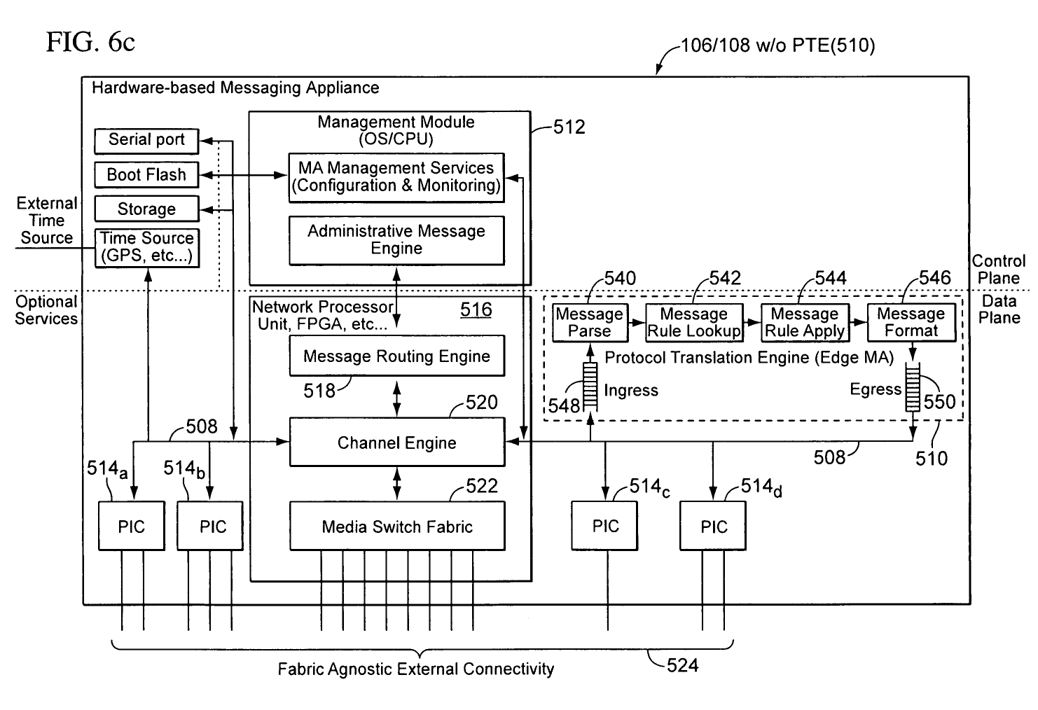

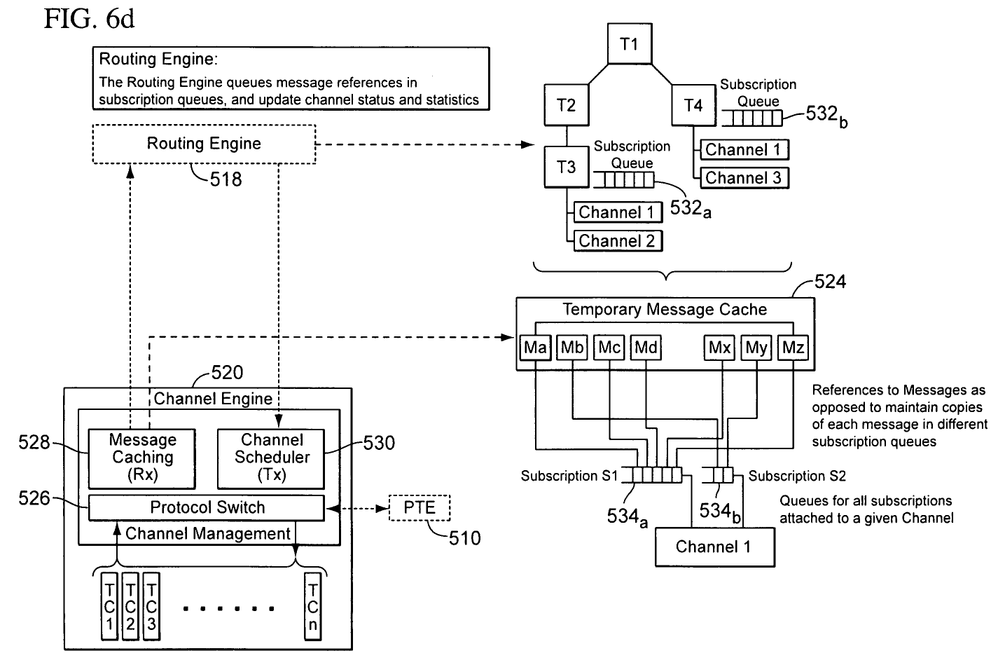

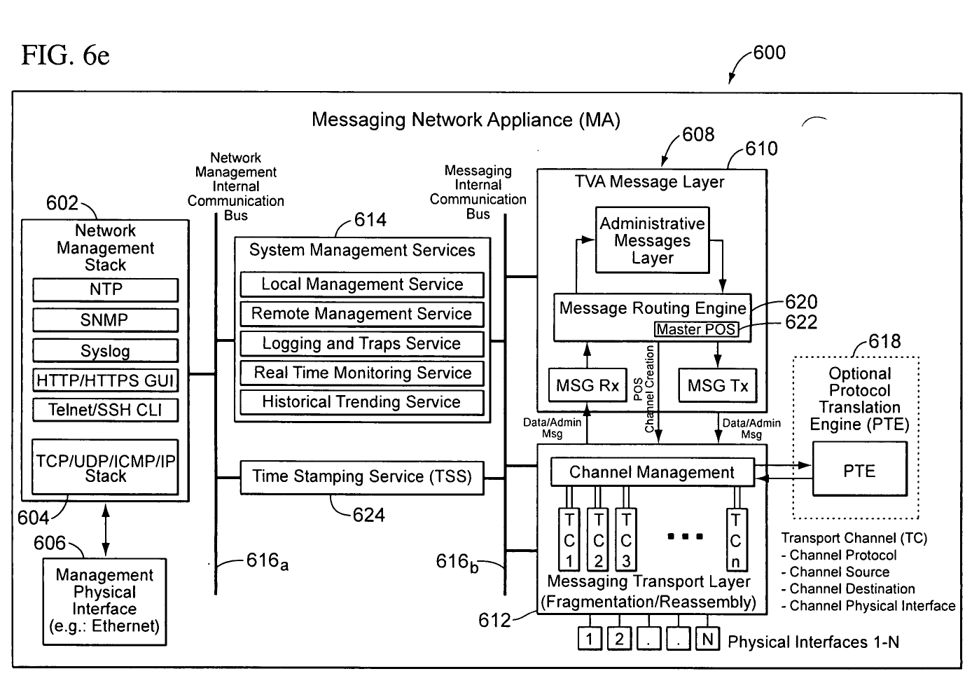

Given the description above of messaging systems with the publish/subscribe middleware architecture, it can be understood that messaging appliances (MAs) have a considerable role in such systems. Accordingly, we turn now to describe the details of hardware-based messaging appliances (MAs) configured in accordance with the principles of the present invention. In one embodiment of the invention, the MA is a standalone appliance. In yet another embodiment of the invention, the MA defines an embedded component (e.g.: line card) inside any network physical component such as a router or a switch. FIGS. 6a, 6b, 6c and 6d are block diagrams illustrating, in various degrees of detail, hardware-based MAs. FIG. 6e illustrates the MA from a functional point of view.

In general, the architecture of an MA is founded on a high-speed interconnect bus to which various hardware modules are connected. FIGS. 6a and 6b illustrate the basic architecture of edge and core MAs 106 and 108, respectively, in which the high-speed interconnect bus 508 interconnects the various hardware modules 502, 504 and 506. The edge MA (106, FIG. 6a) is shown configured with the protocol translation engine (PTE) module 510 while the core MA (108, FIG. 6b) is shown configured without the PTE module. As further shown, in one embodiment the high-speed interconnect bus is structured as a PCI/PCI-X bus tree where the hardware modules are PCI/PCI-X peripherals. PCI (peripheral component interconnect) is known generally as an interconnection system for computer high speed operation. PCI-X (peripheral component interconnect extended) is a computer bus technology (the “data pipes” between parts of a computer) for greater speed of computer operations. In alternative embodiments, the high-speed interconnect bus is structured as the Infiniband or direct memory connect mediums. In yet another embodiment, the hardware modules are blades connected via switched fabric backplane, such as Advanced Telecom Computing Architecture (ATCA).

The various hardware modules of each MA can be divided essentially into thee groups, the group of control plane modules 502, the group of data plane modules 504 and the group of service plane modules 506. The group of control plane modules handles MA management functions, including configuration and monitoring. Examples of MA management functions include configuration of network management services, configuration of hardware modules that are connected to the high-speed interconnect bus, and monitoring of these hardware modules. The group of data plane modules handles data message routing and message forwarding functions. This module group handles messages transported by the publish/subscribe middleware system as well as administrative messages, although administrative messages can be delivered also to the control plane modules group. The group of service plane modules handles other local services that can be used seamlessly by the control and data plane modules. In one embodiment, a local service might be time synchronization service for latency measurements provided with a GPS card, or any externally synchronized device that would receive a microsecond granularity signal on-a periodic basis. The three module groups are described below in further detail in conjunction with FIG. 6c, as well as FIGS. 6a and 6b.

The group of control plane modules 502 includes a management module 512. Typically, the management module incorporates one or more CPUs running an operating system (OS), such as Linux, Solaris, Windows or any other OS. Alternatively, the management module incorporates one or more CPUs in a blade (server) installed in a high-speed interconnect chassis. In yet another configuration, the management module incorporates one or more CPUs running in a high-performance rack-mounted host server.

In addition, the management module 512 includes one or more logical configuration paths. A first configuration path is established via a command line interface (CLI) over a serial interface or network connection through which a system administrator can enter configuration commands. The logical configuration path over the CLI is typically established in order to provide the initial configuration information for the MA allowing it to establish connectivity with the P&M system. Such initial configuration provides information such as, but not limited to, a local management IP address, a default gateway, and IP addresses of the P&M systems to which the MA connects. As part of the boot process, all or a subset of this configuration might be used to initialize the various hardware components in the MA.

A second configuration path is established by administrative messages routed through the publish/subscribe middleware system. As soon as the MA has connectivity to the P&M system or systems, it will registers to at least one P&M system and retrieve its configuration. This configuration is sent to the MA via administrative messages that are delivered locally to the management module 512.

The MA configuration information retrieved from a P&M system contains parameters, addresses and the like. Examples of the information an MA configuration might contain include Syslog configuration parameters, network time protocol (NTP) configuration parameters, domain name server (DNS) information, remote access policy via SSH/Telnet and/or HTTP/HTTPS, authentication methods (Radius/Tacacs), publish/subscribe entitlements, MA routing information indicating connectivity to neighboring MAs or APIs, and more.

The entire MA configuration can be cached on the management module in one or a combination of memory resources associated with the management module. The MA configuration can be cached, for example, in the memory space at the management module, a volatile storage area (such as a RAM disk used for root file system), in a non-volatile storage area (such as a memory flash card or hard drive), or in any combination of those. If persistent after reboot, this cached configuration can be loaded by the MA at startup time.

In one implementation, the cached configuration contains also a configuration identifier (ID) provided by the P&M system. This configuration ID can be used for comparison, where the MA configuration ID cached locally on the MA is compared to the MA configuration ID presently on the P&M system. If the configuration IDs in both the MA and P&M are identical, the MA can bypass the configuration transfer phase, and apply the locally cached configuration. Also, in the event that the P&M system is not reachable, the MA can revert back to the last known configuration, whether or not it is the most recent one, rather than go through startup without any configuration.

Once the MA is up and running, the control plane module group (the management module 152) monitors the health and any indicia of status change (status change events) associated with various logical components within the hardware modules of the MA. For instance, status change events can indicate an API registration, an MA registration, or they can be subscribe/unsubscribe events. These and other status change events are generated and can be stored for some time locally at the MA. The MA reports these events to a system monitoring tool.

The MA can be remotely monitored via a simple network management protocol (SNMP) or through P&M real-time monitoring and/or historical trending UI (User Interface) modules that track raw statistical data streamed from the MA to the P&M. This raw statistical data can be batched per period of time in order to reduce the amount of monitoring traffic being generated. Alternatively, this raw statistical data can be aggregated and processed (e.g., through computation) per period of time.

The control plane module of the MA is responsible also for loading new or old firmware versions on specific hardware modules. In one instance, firmware images are made available to the MA via updates over the wire. During these maintenance windows, the new firmware image is first downloaded from the P&M system to the MA. Upon receipt and validation of the firmware image, the MA uploads the image on the target hardware module. When the upgrade is complete, the hardware module might have to be rebooted for the upgrade to take effect. There are a number of ways to validate the software image, one of which involves an embedded signature. For instance, the MA checks whether the image has been signed by the system vendor or one of its authorized licensees or affiliates (e.g., Tervela or any licensee of Tervela™ technology).

Preferably, traffic of system management messages is routed through a dedicated physical interface. This approach allows creation of different virtual LANs (VLANs) for the management and data messages traffic. It can be done by configuring the switch port, which is connected to a particular physical interface, to dedicate this interface to the VLAN for all system management messages traffic. Then, all or a subset of the remaining physical interfaces would be dedicated to the VLAN for data messages. By differentiating between and separating the different types of traffic in the underlying network fabric, it is easier to manage independently the performance of each type of message traffic.

Another function of the control plane module group is the function of monitoring the status of subscription tables and statistics on the message transport channels between the MA and the APIs. Based on this information, a protocol optimization service (POS) in the MA can make decisions on whether or not to switch, for instance, from unicast channels to multicast channels, and vice versa. Similarly, in cases where slow consumers are discovered, the POS can decide whether or not to move the slow consumers from the multicast channel to a unicast channel in order to preserve the operational integrity of the multicast channel.

The aforementioned group of data plane modules (502, FIGS. 6a And 6b) includes one or more physical interface cards (PICs; 514, FIGS. 6a-c), such as Fast Ethernet, Gigabit Ethernet, 10 Gigabit Ethernet, Gigabit-speed memory interconnect, and the like. These data plane PICs are logically controlled by one or more message processor units (MPUs). An MPU is implemented as a network processor unit 516, FPGA, MIPS-based network processing card,custom ASIC, or an embedded solution on any platform.

The PICs 514 handle frames containing one or more messages. Frames enter the MA through an ingress PIC, which contain one or more chipsets to control the media-specific processing. In one configuration, a PIC is further responsible for the OSI Layer-4 termination, which corresponds to the channel transport-specific termination, such as TCP or UDP termination. As a result, the data forwarded from a PIC to the MPU might contain only the stream of messages from the incoming frames. In another configuration, a PIC sends the network packets to a channel engine 520 running on the MPU. The channel engine performs the OSI Layer-3 to Layer-4 processing before handing over messages contained in the network packet.

In yet another configuration, a PIC 514 is a memory interconnect interface that forwards messages to the channel engine 520 using a channel-specific transport protocol. And, in this case, the channel engine will have a channel-specific processing adapter to parse and extract the messages from the incoming data.

The PIC, in yet another configuration, might have a dedicated chipset and on-board memory to perform fast forwarding of message frames as opposed to passing these frames to the PMU to be routed by the message routing engine 518. In order to implement such fast forwarding approach, the global routing (subscription) table is distributed in whole or, preferably, in part from the MPU to a forwarding cache in the PIC. With this routing table in its forwarding cache, an ingress PIC can inspect incoming message frames to identify in them one or more topics or any subsets thereof and based on such topics directly forward the frames to an egress PIC. Note that if a subscription table distributed to the forwarding cache of a PIC represents only a subset of the global subscription table, the benefit derived is faster routing lookups and, as a result, faster message forwarding.

The aforementioned MPU 516, is responsible, via its channel engine 520, for managing the communications interface between the PICs and the message routing engine 518. The MPU is further responsible, via its message routing engine 518, for maintaining the subscription table and matching incoming messages to subscriptions and channels. These functions can be implemented in a number of ways, in one of which they are configured to run on different micro-engines or microchips and in another one of which they are configured to run on separate CPU cores. In the second case, each core employs a standard or custom network stack. In yet another implementation, these functions are configured to run on a multi-core CPU on top of a real-time OS.

The preferred MPU has also an embedded media switch fabric 522. Because the message transport channels are fabric-agnostic, the MPU can interface to any type of physical medium 524. Messages forwarded from the PICs, and optionally from the media switch fabric, are received by the channel engine 520 and then forwarded to the message routing engine 518.

The channel engine 520 manages the message transport channel queues. FIG. 6d illustrates message queuing using a temporary message cache 524 and message forwarding using the channel engine 520.

On the receive side, the messages are removed from the channel queues. In some instances, message transport channels might have special priorities. Message transport channel prioritization is useful when more than one channel has pending messages. For instance, message retransmission requests should be forwarded first; thus, it might make sense to create a different channel for retransmission requests. Delaying a retransmission request may result in more retransmission requests; this is typically what happens with broadcast/multicast storms.

For an edge MA 108, a protocol switch 526 in the channel engine 520 checks whether the message requires a protocol translation. If translation is necessary, the message is sent to the protocol translation engine 510. When the message is converted by the protocol translation engine to the native protocol (e.g., Tervela™ protocol) format, it is forwarded to a caching component 528. The caching component puts the message in a temporary message cache 524, where the message will be temporarily available for retransmission. The message will be removed or overwritten by another message after its time period elapses. In one configuration, the temporary message cache is implemented as a simple memory ring buffer that is shared with the message routing engine 518. Preferably, the temporary message cache lookup is optimized in order to speed up the retransmission process by, for example, maintaining an index that maps the message serial numbers to the actual messages in the cache. The message routing engine 518 takes the message from the temporary message cache 524, performs the subscription lookup, and returns the list of channels for forwarding a copy of this message.

Some of the administrative messages may have to be delivered locally to the management module 512 over the shared bus 508 (FIGS. 6a, 6b and 6c). Messages that are delivered locally can be forwarded also throughout the publish/subscribe middleware system. In one implementation, the message routing engine 518 pushes the copy of a message on the queue of each channel. In another implementation, the message routing engine 518 only queues a reference or a pointer to the message where the message itself remains in the temporary message cache. This approach has the benefit of optimizing the memory usage on the MPU, since more than one queue might reference the same message. Also, the message routing engine 518 can append in a subscription message queue 532 the reference (e.g., pointer) to a message, where the subscription queues for subscriptions S1 and S2 point to messages in the temporary message cache 524.

Then, each channel maintains a list of references to all the subscriptions that are associated with it. This approach has the benefit of enabling a subscription-level message processing rather than merely channel-level message processing. Effectively, these subscription queues provide a way to index the messages on a per-subscription basis as well as on a per-channel basis; thus, it shortens the lookup time if messages need to be processed for a given subscription. For instance, in one embodiment, real-time conflation logic is used on a per-subscription basis. This also allows the MPU to perform value-added calculations, for instance, volume weighted average price (VWAP) calculation for stock market quote messages.

On the transmit side, the message routing engine 518 marks or flags channels that have pending queued messages. This allows the channel scheduler 530 to know which channel or channels require attention or has a special priority. Channel priorities can be shuffled to provide quality of service (QoS) functionality. For example, QoS functionality is implemented based on message header fields alone or in combination with message topics. At this point, the message routing engine 518 moves to the next message in the message cache ring buffer.

The channel scheduler 530 runs through all the channels that have messages queued and forwards the pending messages using a channel-specific communication policy. The policy determines what type of transmission protocol is used, unicast, multicast, or other. A communication policy might be negotiated when the channel is created, or it might be updated in real-time based on resource utilization patterns, such as network bandwidth utilization, message, packet delay, jitter, loss etc. A channel-specific communication policy can be further based on message flow control parameters negotiated with one or more channel destinations, such as neighboring MAs or APIs. For instance, instead of sending all the messages, it might drop one message out of N messages. Thus one aspect associated with this policy is message flow control.

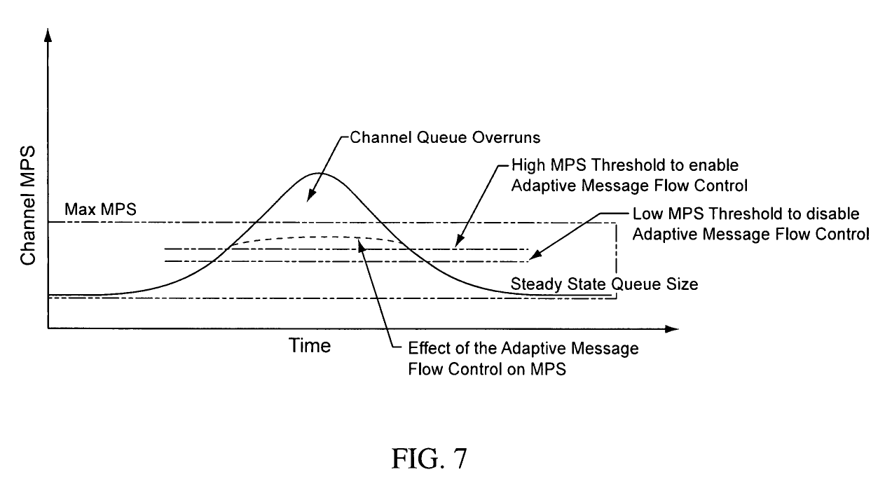

FIG. 7 illustrates the effects of a real-time message flow control (MFC) algorithm. According to this algorithm, the size of a channel queue can operate as a threshold parameter. For instance, messages delivered through a particular channel accumulate in its channel queue at the receiving appliance side, and as this channel queue grows its size may reach a high threshold that it cannot safely exceed without the channel possibly failing to keep up with the flow of incoming messages. When getting close to this situation, where the channel is at risk of reaching its maximum capacity, the receiving messaging appliance can activate the MFC before the channel queue is overrun. The MFC is turned off when the queue shrinks and its size becomes smaller than a low threshold. The difference between the high and low thresholds is set to be sufficient for producing this so called hysteresis behavior, where the MFC is turned on at a higher queue size value than that at which it is turned off. This threshold difference avoids frequent on-off oscillations of the message flow control that would otherwise occur as the queue size hovers around the high threshold. Thus, to avoid queue overruns on the messaging receiver side, the rate of incoming messages can be kept in check with a real-time, dynamic MFC which keeps the rate below the maximum channel capacity.

As an alternative to the hystresis-based MFC algorithm where messages are dropped when the channel queue nears its capacity, the real-time, dynamic MFC can operates to blend the data or apply some conflation algorithm on the subscription queues. However, because this operation may require an additional message transformation, it may revert to a slow forwarding path as opposed to remaining on the fast forwarding path. This would prevent the message transformation from having a negative impact on the messaging throughput. The additional message transformation is performed by a processor similar to the protocol translation engine. Examples of such processor include an NPU (network processing unit), a semantic processor, a separate micro-engine on the MPU and the like.

For greater efficiency, the real-time conflation or subscription-level message processing can be distributed between the sender and the receiver. For instance, in the case where subscription-level message processing is requested by only one subscriber, it would make sense to push it downstream on the receiver side as opposed to performing it on the sender side. However, if more than one consumer of the data is requesting the same subscription-level message processing, it would make more sense to perform it upstream on the sender side. The purpose of distributing the workload between the sender and receiver-side of a channel is to optimally use the available combined processing resources.

The transport channel itself handles the transport-specific processing which, much like on the receive side, is done on the MPU or PIC with a system-on-chip. When the channel packs multiple messages in a single frame it can keep message latency below the maximum acceptable latency and ease the stress on the receive side by freeing some processing resources. It is sometimes more efficient to receive fewer large frames than processing many small frames. This is especially true for the API that might run on a typical OS using generic computer hardware components including CPU, memory and NICs. Typical NICs are designed to generate an OS interrupt for each received frame, which in-turn reduces the application-level processing time available for the API to deliver messages to the subscribing applications.

As mentioned above, only an edge MA has a protocol translation engine (PTE). In the edge MA, the data plane modules are capable of forwarding incoming messages to the PTE (510, FIGS. 6a, 6c and 6d. This forwarding decision occurs at the MPU 512 by the protocol switch 526 running as part of the channel engine 520. When the incoming or outgoing message protocol is different from the native message protocol the message is forwarded to the PTE.

The PTE can be implemented a number of ways using hardware and software in any combination, including using, for instance, a semantic processor, a FPGA, an NPU, or embedded software modules executing under a real-time, embedded OS running on a network-oriented system-on-chip or MIPS-based processors. As shown in the example of FIG. 6c, the PTE has pipelined task-oriented micro-engines, including the message parsing, message rule lookup, message rule apply and message format engines. The architectural constraint in building such a hardware module is to keep the message transformation latency low while allowing multiple, complex grammar transformations between protocols. Another constraint is to make the firmware upgrades of the protocol conversion syntax (grammar) very flexible and independent from the underlying hardware.

First in the pipeline, the message parsing engine 540, takes a message that is de-queued from the PTE ingress queue 548, and then parses, identifies and tokenizes this message. The message parsing engine forwards the result to the message rule lookup engine 542. The message rule lookup engine performs a rules lookup based on the message content and retrieves the matching rules which need to be applied. The message content and the matching rules are then passed to the message rule apply engine 544. The rules apply engine transforms tokens of the message according to the matching rules and the resulting tokenized message is forwarded to the message format engine 546. The message format engine rebuilds the message body and header, according to the message protocol, native or external, and sends it back to the PTE egress queue 550. The processed (translated) messages are shipped back on the shared bus 508 to the channel engine 520.

As shown in FIGS. 6a and 6b, the various hardware modules of each MA can be divided essentially into thee groups, of which the above-described groups of control plane modules 502 and data plane modules 504 interface with and use the services provided by the group of service plane modules 506. To this end, the service plane module group includes a collection of service modules for use by both the control plane module group and the data plane module group. An example of a service module is the external time source, such as a GPS (global positioning system) card. This service module can be used by any other hardware modules to get an accurate timestamp. For instance, each frame and message routed through the data plane can be stamped when it enters and/or exits the MA. This embedded timestamp information can be later used to perform latency measurements.

As a result, external latency computation, for instance, involves a correlation of embedded timestamps from the data stream with the measured timestamps when frames enter the MA. Then, by tracking this external latency over time, the MA is able to establish a latency trend and detect any drift in external latency, as well as embed this information back in the data stream. This latency drift can be subsequently employed by downstream nodes on the messaging path, or subscribing applications to make business-level decisions and gain a competitive edge.

For tracking the latency and other messaging system statistics, the MA has one or more storage devices. The storage devices hold temporary data, such as statistical data obtained from the different hardware components, networking and messaging traffic profile, and more. In one implementation, the one or more storage devices include a flash memory device that holds initialization data for MA startup (boot up or reboot). For this purpose, this non-volatile memory device contains the kernel and the root ramdisk which are necessary for the boot operation of the management module; and it preferably also contain the default, startup and running configurations.

This non-volatile memory may further hold encryption keys, digital signatures and certificates for managing secure transmission of the messages. In one example, SSL (secure socket layer) protocol uses the public-and-private (asymmetric) key encryption system, which also includes the use of a digital certificate. Similarly, PKI (public key infrastructure) enables users of a public network such as the Internet to securely and privately exchange data through the use of a public and a private cryptographic key pair that is obtained and shared through a trusted authority.

The hardware modules can be described in terms of functionality they provide as shown in FIG. 6e. Among the functional aspects of the messaging appliance are the network management stack 602, the physical interface management 606, the system management services 614, the time stamping service 624, the messaging layer 608 and, in edge messaging appliances, the protocol translation engine 618. These functional aspects relate back to the hardware modules as described below.

For instance, the network management stack (602) runs on the management module (512). The TCP/UDP/IP stack (604) is part of the Operating System that runs on the CPU of the management module. NTP, SNMP, Syslog, HTTP/HTTPS web server, Telnet/SSH CLI services are standard network services running on top of the OS.

The System Management Services (614) are also running on the management module (512). These system management services manage the interface between the network management stack and the messaging components, including the configuration and the monitoring of the system.

The Time Stamping Service (624) might be distributed to multiple hardware components. Any hardware component (including the management module), requiring an accurate timestamp, includes a Time Stamping Service that interface with the Service Plane hardware module Time Source.

The buses 616a and 616b are logical buses, which connect logical/functional modules, as opposed to be hardware or software buses, which connect hardware or software modules.

The TVA Message Layer (610) is distributed between the management module and the Message Routing Engine (518), running on the message processing unit (516). The administrative messages are delivered locally to the Administrative Message Engine running on the management module (512). The Message Routing Engine (620) is running on the Message Routing Engine micro-engine on the Message Processing Unit (516). The Messaging Transport Layer (612) is running mainly on the Channel Engine micro-engine (520). In some cases, part of the channel transport logic is implemented on some transport-aware PIC 514a-d. In one embodiment of this invention, this transport-aware PIC could be a TCP Offload Engine interface that would perform the TCP termination. As a result, part of the channel transport logic is performed on the PIC as opposed to be performed on the Channel Engine. The Message Rx and Tx is distributed between the Channel Engine and the Message Routing Engine, since you have two micro-engine talking to each other. The Protocol Translation Engine (618) is represented by the Optional PTE (510) for the Edge MA.

In sum, the present invention provides a new approach to messaging and more specifically a new publish/subscribe middleware system with a hardware-based messaging appliance that has a significant role in improving the effectiveness of messaging systems. Although the present invention has been described in considerable detail with reference to certain preferred versions thereof, other versions are possible. Therefore, the spirit and scope of the appended claims should not be limited to the description of the preferred versions contained herein.

What is claimed is:

1. A hardware-based messaging appliance in a publish/subscribe middleware system, comprising:
an interconnect bus; and
hardware modules interconnected via the interconnect bus, the hardware modules being divided into groups, a first one being a control plane module group for handling messaging appliance management functions, a second one being a data plane module group for handling message routing functions alone or in addition to message transformation functions, and a third one being a service plane module group for handling service functions utilized by the first and second groups of hardware modules.

2. A hardware-based messaging appliance as in claim 1, wherein the messaging appliance management functions include configuration and monitoring functions.

3. A hardware-based messaging appliance as in claim 2, wherein the configuration function includes configuration of the publish/subscribe middleware system.

4. A hardware-based messaging appliance as in claim 1, wherein the message routing function includes message forwarding and routing executed by dynamically selecting a message transmission protocol and a message routing path.

5. A hardware-based messaging appliance as in claim 1, wherein the service functions include time source and synchronization functions.

6. A hardware-based messaging appliance as in claim 1, wherein the control plane module group includes a management module and one or more logical configuration paths.

7. A hardware-based messaging appliance as in claim 6, wherein the management module incorporates one or more central processing units (CPUs) in a computer, a blade server or a host server.

8. A hardware-based messaging appliance as in claim 7, wherein the CPUs in the management module execute program code under any operating system including Linux, Solaris, Unix and Windows.

9. A hardware-based messaging appliance as in claim 6, wherein each logical configuration path is one of a plurality of paths, a first path being established via a command line interface (CLI) over a serial interface or a network connection, and a second path being established by administrative messages routed through the publish/subscribe middleware system.

10. A hardware-based messaging appliance as in claim 9, wherein the logical configuration paths are used for configuration information, and wherein the administrative messages contain such configuration information, including one or more of Syslog configuration parameters, network time protocol (NTP) configuration parameters, domain name server (DNS) information, remote access policy, authentication methods, publish/subscribe entitlements and message routing information.

11. A hardware-based messaging appliance as in claim 10, wherein the message routing function is neighbor based and the message routing information indicates connectivity to each neighboring messaging appliance or application programming interface.

12. A hardware-based messaging appliance as in claim 10, further including a memory in which the configuration information is stored for later retrieval during reboot, if the information is persistent.

13. A hardware-based messaging appliance as in claim 12, wherein the stored configuration information has a configuration identification associated therewith which is used to determine if the configuration information is current or needs to be replaced with more up-to-date configuration information.

14. A hardware-based messaging appliance as in claim 1, wherein the messaging appliance management functions further include a health monitoring function and a status change events monitoring function, both of which becoming active after startup or reboot is underway or complete.

15. A hardware-based messaging appliance as in claim 14, wherein the status change events monitoring function detects events including API (application programming interface) registration, messaging appliance registration, and subscribe and unsubscribe events.

16. A hardware-based messaging appliance as in claim 1, wherein the messaging appliance management functions further include the function of uploading firmware images on the hardware modules.

17. A hardware-based messaging appliance as in claim 16, wherein the function of uploading firmware images includes validation of the firmware images.

18. A hardware-based messaging appliance as in claim 9, further including physical interfaces one or more of which being dedicated for handling administrative message traffic associated with the messaging appliance management functions and the remaining physical interfaces are available for data message traffic, such that administrative message traffic is not commingled with and overloading the physical interfaces for data message traffic.

19. A hardware-based messaging appliance as in claim 1 further comprising message transport channels, wherein the messaging appliance management functions further include the function of monitoring subscription tables and statistical data associated with the message transport channels.

20. A hardware-based messaging appliance as in claim 19, wherein the statistical data is monitored for determining whether to switch from channel to channel, in cases where slow consumers are discovered, whether to move the slow consumers to a consumer-optimized channel.

21. A hardware-based messaging appliance as in claim 1, wherein the group of data plane modules includes one or more physical interface cards (PICs) and a message processing unit (MPU) for controlling the PICs.

22. A hardware-based messaging appliance as in claim 21, further comprising a serial port providing access to the management module for allowing a command line interface (CLI).

23. A hardware-based messaging appliance as in claim 21, wherein the PICs handle frames with one or more messages.

24. A hardware-based messaging appliance as in claim 21, further comprising a global routing table, a copy of part or all of which being sent to a forwarding memory associated with each PIC.

25. A hardware-based messaging appliance as in claim 24, wherein the message routing functions involve routing table lookup in the forwarding memory table which is topic based.

26. A hardware-based messaging appliance as in claim 15, wherein the topic-based routing table lookup identifies one or more paths for a message between two PICs or between one PIC and itself.

27. A hardware-based messaging appliance as in claim 1, wherein the group of service plane modules includes an external time source that is accessible by any of the hardware modules for obtaining a timestamp.

28. A hardware-based messaging appliance as in claim 27, wherein the timestamp is embedded in messages and later used for assessing latency.

29. A hardware-based messaging appliance as in claim 28, further including a non-volatile memory for accumulating over time message traffic profile characterized by statistical data including the latency, the accumulated message traffic profile establishing a trend which indicates a latency drift if it materializes.

30. A hardware-based messaging appliance as in claim 29, further including, for security, a non-volatile memory for holding encryption keys and certificates.

31. A hardware-based messaging appliance as in claim 1 configured as either an edge or a core messaging appliance with the edge messaging appliance having a protocol translation engine (PTE) for translating between external and native message protocols.

32. A hardware-based messaging appliance in a publish/subscribe middleware system, comprising:
an interconnect bus;
a management module having management service and administrative message engines interfacing with each other, the management module being configured to handle configuration and monitoring functions;
a message processing unit having a message routing engine and a media switch fabric with a channel engine interfacing between them, the message processing unit being configured to handle message routing functions;
one or more physical interface cards (PICs) for handling messages received or routed by the hardware messaging appliance and destined to or leaving the management module and the message processing unit;
a service module including a time source, wherein the management module, the message processing module, the one or more PICs and the service module, are interconnected via the interconnect bus.

33. A hardware-based messaging appliance as in claim 32, further comprising a non-volatile boot memory for holding configuration information and a temporary message storage which is maintained in memory of the message processing unit.

34. A hardware-based messaging appliance as in claim 32, further comprising, for each of the PICs, a memory with storage for holding any portion of a global system routing table.

35. A hardware-based messaging appliance as in claim 32, wherein external connectivity is fabric-agnostic, and therefore, the PICs and media switch fabric can be of any fabric type.

36. A hardware-based messaging appliance as in claim 32, further comprising a serial port for command line interface.

37. A hardware-based messaging appliance as in claim 32, further comprising a protocol translation engine (PTE) for translating between external and native message protocols.

38. A hardware-based messaging appliance as in claim 37 being configured as an edge or a core messaging appliance, wherein the edge messaging appliance includes the PTE.

39. A hardware-based messaging appliance as in claim 37, wherein the PTE includes pipe-lined engines, including message parse, message rule lookup, message rule apply and message format engines, and message ingress and egress queues, and wherein the PTE is connected to the interconnect bus.

40. A hardware-based messaging appliance as in claim 32, wherein the message routing functions are executed by dynamically selecting a message transmission protocol and a message routing path.

41. A hardware-based messaging appliance as in claim 32, wherein the channel engine includes channel management module and a plurality of transport channels for handling incoming and outgoing messages.

42. A hardware-based messaging appliance as in claim 41, wherein the channel management module includes a message caching module for temporarily caching received messages, a channel scheduler for prioritizing transmit channels, and a protocol switch for determining protocol translation requirements.

43. A hardware-based messaging appliance as in claim 41, wherein each of the plurality of transport channels has a message ingress and egress queue the size of which being used as a criteria for activating message flow control.

44. A hardware-based messaging appliance as in claim 43, wherein channel capacity is deemed a high threshold and a lower value is deemed low threshold, the message flow control being activated when the queue size nears the high threshold and is deactivated when the queue size shrinks to below the low threshold.

45. A system with publish/subscribe middleware architecture, comprising:
one or more than one messaging appliance configured for receiving and routing messages, each messaging appliance having an interconnect bus and hardware modules interconnected via the interconnect bus, the hardware modules being divided into groups, a first one being a control plane module group for handling messaging appliance management functions, a second one being a data plane module group for handling message routing functions, and a third one being a service plane module group for handling service functions utilized by the first and second groups of hardware modules;
an interconnect medium; and
a provisioning and management appliance linked via the interconnect medium and configured for exchanging administrative messages with each messaging appliance,
wherein each messaging appliance is further configured to execute the routing of messages by dynamically selecting a message transmission protocol and a message routing path.

46. A system as in claim 45, wherein the messaging appliances include one or more of an edge messaging appliance and a core messaging appliance.

47. A system as in claim 46, wherein each edge messaging appliance includes a protocol transformation engine for transforming incoming messages from an external protocol to a native protocol and for transforming routed messages from the native protocol to the external protocol.
